(19) United States
(12) Patent Application Publication
(10) Pub. No.: US 2003/0103085 A1
(43) Pub. Date: Jun. 5, 2003

(54) User interface display system providing user interactive image elements

(75) Inventors: David Anuszewski, Pottstown, PA (US); Jeff LoBello, Pottstown, PA (US)

Correspondence Address: Elsa Keller, Intellectual Property Department, Siemens Corporation, 186 Wood Avenue South, Iselin, NJ, 08830, US

(73) Assignee: Siemens Medical Solutions Health Services Corporation

(21) Appl. No.: 10/157,708

(22) Filed: May 29, 2002

Related U.S. Application Data
(60) Provisional application No. 60/334,295, filed on Nov. 30, 2001.

(51) Int. Cl. G09G 5/00

(52) U.S. Cl. 345/810

(57) ABSTRACT

A system for generating a user interface display image including an image element responsive to user selection is disclosed. A display processor is provided for initiating generation of data representing an image element for presentation in a displayed image. A database is provided for associating the image element with an executable procedure for responding to user selection of the image element. An event processor is further included for providing the procedure with an event identifier for use in displaying an action desired upon user selection of said image element in the displayed image and an image element identifier for identifying the image element from a plurality of image elements, in response to user selection of the image element in the displayed image.

This is a non-provisional application of provisional application serial No. 60/334,295 by David Anuszewski et al. filed Nov. 30, 2001.

### FIELD OF THE INVENTION

The present invention relates generally to user interface displays. In particular, the present invention is associated with systems and methods to provide a user interactive image element for a user interface display.

### BACKGROUND OF THE INVENTION

Dynamic Hyper-text Mark-up Language (DHTML) is a platform-independent computer graphic processing language that is particularly useful for the development of User Interface (UI) user interactive image elements for software applications, such as network applications. In particular, DHTML allows changes to be made and displayed after a static hyper-text mark-up language (HTML) UI has been loaded.

Many software applications use browsers to deploy their UI and accompanying user interactive image elements. While software development using browser technology is fairly straightforward, a significant number of standard UI tools for applications are not available. Without some common library of user interactive image elements, each application developer is forced to implement similar functions in potentially inconsistent ways. As a result, the separate development of various applications for a common manufacturer will invariably generate different implementations for common functions. Customers using these various applications will thus be presented with applications that are devoid of a common look and feel.

In the implementation of browser-deployed UI user interactive image elements, DHTML is used to dynamically generate HTML code in an electronic document at run time. Under this methodology, the constructor of an object will generate the necessary HTML and change the inner HTML attributes of a container within the document. While this approach ensures the necessary HTML elements will be present, it has an unacceptable level of performance in that rendering HTML dynamically is extremely inefficient from a processing standpoint.

Accordingly, there is a need for a method and apparatus for providing a common framework of functionality for user interfaces that addresses certain problems of existing technologies.

### SUMMARY OF THE INVENTION

Embodiments of the present invention are associated with systems and methods to provide a user interactive image element for a user interface display. According to some embodiments, a display processor initiates generation of data representing an image element for presentation in a displayed image. In addition, a database associates the image element with an executable procedure for responding to user selection of the image element. An event processor provides the procedure with (a) an event identifier for use in displaying an action desired upon user selection of the image element in the displayed image and (b) an image element identifier for identifying the image element from a plurality of image elements in response to user selection of the image element in the displayed image.

### BRIEF DESCRIPTION OF THE DRAWINGS

Further aspects of the instant invention will be more readily appreciated upon review of the detailed description of the preferred embodiments included below when taken in conjunction with the accompanying drawings, of which:

FIG. 1 is a block diagram of an exemplary server for storing and disseminating a library of standardized graphical images and user interactive image element functions;

FIG. 2 is a schematic diagram of an exemplary HTML document generated using the user interactive image elements provided by the server of FIG. 1;

FIG. 3 is a flowchart depicting an exemplary software development procedure according to some embodiments of the present invention;

FIG. 4 is a flowchart depicting an exemplary procedure for executing a standardized command performed by a user interacting with an online software application; and

FIG. 5 is an exemplary screen display depicting image elements within a user interface of a network application, according to some embodiments of the present invention.

### DETAILED DESCRIPTION OF THE INVENTION

Applicants have recognized that there is a need for a UI display system, method and apparatus for providing user interactive image elements that overcomes drawbacks of other systems. According to some embodiments, a UI display system utilizes a generic design to structure the implementation of individual DHTML UI elements, making them easier and more efficient to implement, and providing more controlled consistency for a common look and feel across applications. In some embodiments of the present invention, an environment having common attributes and elements is provided. For example, common attributes and elements of the environment may include:

1) a user interactive image element-specific “wizard” to generate the necessary HTML elements. As used herein, the term “wizard” refers to a utility within an application that helps allow the application to perform a particular task. For example, a “letter wizard” within a word processing application would lead you through the steps of producing different types of correspondence;

2) user interactive image element-specific executable code to implement user interactive image element behavior;

3) generic user interactive image element presentation formatting information to control the default visual style of the browser-based interface;

4) a common “constructor,” which takes the name of the HTML element containing the user interactive image element and the name of the event handling procedure implementing the functions associated with the user interactive image element (for example, the HTML element name is generated by the HTML wizard, and the event handling procedure name may be any unique function name selected for the function). As used herein, the term “constructor” refers to a software development tool allowing, for example only and not by way of limitation, the use of HTML code within a program; and

5) a common event handling mechanism, which will handle individual events defined by the constructor.

A number of UI user interactive image elements may be implemented in a similar fashion to ensure consistency across applications. Pursuant to some embodiments of the present invention, use of such common elements provides consistency across user interfaces and consistency of user interface analysis. According to some embodiments, each of the user interactive image elements are part of an exemplary Internet Common Code (ICC) domain. As with any domain, there will be standard build procedures to generate the necessary image elements and model them to standard graphics locations. The ICC naming convention is provided herein by way of example only and is not to be construed as a limitation in the operation of the present invention. Any unique naming scheme which does not conflict with other computer-implemented processes may readily be used.

For example, such user interactive image elements may involve:

1) a developer's guide that will be available for UI analysis of the user interactive image elements in the implementation of a browser based user interface;

2) an HTML wizard that may be used to generate necessary HTML elements for the user interactive image element. The complexity and sophistication of the wizards will vary from user interactive image element to user interactive image element;

3) a common user-interactive-image-element-specific executable procedure that will be included on every page of an electronic document that uses the user interactive image element. This will be the implementation of the behavior of the user interactive image element; and

4) common user interactive image element presentation formatting information file (or style sheet) to determine a default visual style for the user interactive image element.

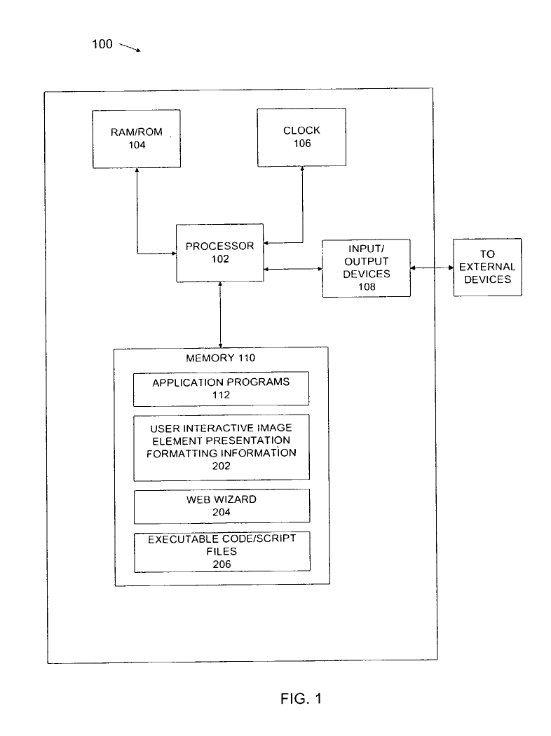

Features of embodiments of the present invention will now be described by referring to FIGS. 1-4, wherein similar components are referenced in like manner. In particular, features of some embodiments for a user interface display system providing user interactive image elements are disclosed.

FIG. 1 shows exemplary components of a server 100 for providing a common library of functionality user interactive image elements according to some embodiments of the present invention. The primary component of server 100 is a processor 102, which may be any commonly available complex instruction set computer (CISC) or reduced instruction set (RISC)-based processor, for example, the PENTIUM 4 microprocessor manufactured by INTEL CORP. The processor 102 may be operatively connected to further known exemplary components, such as random access memory and read only memory (RAM/ROM) 104, a system clock 106, input/output devices 108, and a memory 110. The memory 110, in turn, stores one or more computer operating system and application programs 112, described further below.

The memory 110 may also store a common library of user interactive image elements implemented using the common user interactive image element presentation formatting information 202, a common web wizard 204 and one or more common “applets.” As used herein, the term “applet” refers to a program designed to be executed from within another application. Unlike an application, applets cannot be executed directly from the operating system. With the growing popularity of OLE (object linking and embedding), applets are becoming more prevalent. A well-designed applet may be invoked from many different applications. Web browsers, which are often equipped with Java virtual machines, may interpret applets from Web servers. Because applets are small in file size, cross-platform compatible, and highly secure (can't be used to access users' hard drives), they are ideal for small Internet applications accessible from a browser.

According to one embodiment, an applet is associated with a Java “script file” 206. As used herein, the phrase “script file” refers to a set of processing commands or executable code that may be initiated without user interaction. The commands may be in a particular format or code, including but not limited to JavaScript® and VisualBasic®. Although various descriptions refer to the use of JavaScript® herein, it should be readily appreciated that any other suitable executable code may likewise be used in place of JavaScript®.

Similarly, the common library may be implemented via programming “beans.” As used herein, the term “bean” is associated with a code developed by Sun Microsystems® that defines how objects interact. An object that conforms to this code may be a JavaBean or an ActiveX® control. It may be used by any application that understands these or similar formats. The principal difference between ActiveX® controls and JavaBeans® are that ActiveX® controls may be developed in any programming language but executed only on a Windows® platform, whereas JavaBeans® may be developed only in Java®, but may run on any platform.

The processor 102 may include an event processor for processing event instructions and a display processor for generating graphical attributes for presentation to a user.

The input/output device(s) 108 may be one or more commonly known devices used for receiving system operator inputs, network data, and the like, and transmitting outputs resulting therefrom to the user, an internal component or an external device. Accordingly, exemplary input devices may include a keyboard, a mouse, a voice recognition unit and the like for receiving system operator inputs.

Output devices may include any commonly known devices used to present data to a system operator of the server 100. Accordingly, suitable output devices may include a display, a printer and an audio speaker.

Output devices of the server 100 may further be operable to transmit data over a computer network to other terminals on the network operated, for example, by a user of a network application. Accordingly, output device may include a telephonic or network connection device, such as a telephone modem, a cable modem, a T-1, T-2 or T-3 connection, a digital subscriber line or a network card, wireless transceiver, or the like for communicating data to and from other computer devices over a computer network.

In an embodiment where server 100 accommodates large numbers of users, it is preferred that the communications devices used as input/output devices 108 have sufficient capacity to handle high bandwidth traffic over the network.

The memory 110 may store a plurality of programs 112 which may be any one or more of an operating system such as WINDOWS XP by MICROSOFT CORP, and one or more application programs, such as a web hosting program and a database management program of the type manufactured by ORACLE, each of which may be used in combination to implement various embodiments of the present invention.

The programs 112 may also include processing instructions for accomplishing two-way communications with remote terminals, as described herein. Accordingly, the programs 112 may include web hosting software, such as APACHE, that utilizes JAVASCRIPT, hyper-text mark-up language (HTML), extensible mark-up language (XML), standard generalized markup language (SGML) and other similar programming languages typically used in conjunction with hard-wired or wireless network communication systems. The web hosting software may further use known cryptographic techniques to accomplish secure communications, such as secure socket layer (SSL) communications, over the network.

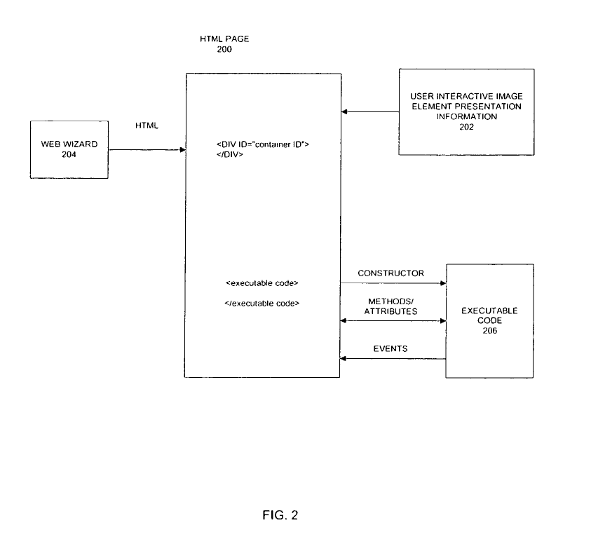

The programs 112 may also include other applications, such as VISUAL BASIC, to allow an operator to generate specific functionality performed by the server 100, as described herein. The programs 112 described above cooperate to form a system which operates in the manner described with respect to FIGS. 2-4.

The server 100 may be operative to communicate over a computer network with a plurality of terminals or other external devices in any of a variety of manners well known in the art. The computer network may be any one or more of a local area network (LAN), a wide-area network (WAN), an intranet environment, an extranet environment, a wireless network or any other type of computer network, such as those enabled over public switched telephone networks. The computer network may also include an Internet-based environment, commonly referred to as the World Wide Web.

The terminals may each be any type of computing device, such as a personal computer, a workstation, a network terminal, a network server, a hand-held remote access device, a personal digital assistant (PDA) or any other device or combination of devices that may accomplish two-way electronic communication with the server 100. Users may access the server 100 through a web browser, such as INTERNET EXPLORER by MICROSOFT CORP, or mobile browsers, such as those developed by PALMSCAPE.

In certain embodiments, the server 100 may be one or more servers which cooperate to perform the functions described herein. In a case where multiple servers act as server 100, such multiple servers may be independently or jointly owned and operated.

In some embodiments, each such server 100 makes services available to the terminals through a standard hypertext transfer protocol/hypertext markup language (HTTP/HTML) interface that utilizes, for example, the Transmission Control Protocol/Internet Protocol (TCP/IP) standard.

User Interface Image Element Generation

To overcome the inefficiencies of dynamic rendering, some embodiments of the present invention provide HTML elements on a page at load time. The problem of identifying necessary HTML elements and asking a UI analysis tool to manually create them is that such a procedure is typically error prone. For example, if one element requires a user interactive image element that is not present, the page will generate an error.

Pursuant to some embodiments of the present invention, individual ICC user interactive image elements are implemented by an HTML Wizard using a software development kit such as, for example, the Visual Basic Web Wizard® software development kit (SDK). The purpose of the Wizard is to automatically generate the HTML code necessary for using a user interactive image element. This will reduce the likelihood of incorrect HTML being present on the page for a given user interactive image element. The majority of necessary HTML code will be generated at design time. UI analysis includes the necessary executable codes and user interactive image element presentation formatting information to allow the user interactive image elements to work correctly.

Turning now to FIG. 2, therein is depicted an exemplary structure for an HTML page 200 generated according to some embodiments of the present invention. As shown in FIG. 2, a Web Wizard 204 is used to generate HTML code that is inserted into the HTML page 200. Each user interactive image element implementation may be re-used if its HTML “container” is generated from the Wizard 204. As used herein, the term “container” refers to beginning and ending tags which divide up a Web page into one or more sections, such as the header information and the part of the page which contains the displayed text and graphics. The tags may correspond to a plurality of attributes for a section of a Web document.

A link to common user interactive image element presentation formatting information 202 is included for a particular user interactive image element provided on the page 200. The user interactive image element presentation formatting information 202 defines the look and feel of the particular user interactive image element in a standardized manner common to a plurality of separate software applications. A source link to a executable code 206 that includes standardized methods and properties of the user interactive image element is likewise included.

A procedure that executes the user interactive image element is individually provided and may include an individual constructor for the user interactive image element which, in turn, manipulates attributes of the user interactive image element in response to a user-initiated event on the HTML page 200. The user interactive image element uses a report of events from the executable code 206 to notify the HTML page 200 of user actions on the user interactive image element. Individual event identifiers may be simple numbers that uniquely identify each event and may be stored in an event log file, that may be titled “ICCEvents.js” in the exemplary ICC domain naming scheme. This file is included on each page that uses an ICC user interactive image element.

According to some embodiments, individual ICC user interactive image elements consist of at least one object. In order to use an ICC user interactive image element, the HTML page includes an object corresponding to the user interactive image element. In some embodiments, individual interactions with the object are named according to the convention “ICC<control name>.” For example, the user interactive image element name “ICCTree” could be used as the name of a tree control. In this regard, a tree control may comprise an interactive image element that portrays hierarchical relationships between objects such as directory folders, document sections, business departments and the like. A user may interact with a tree control to explore and expand “branches” of the portrayed relationships.

Functions other than tree controls may likewise be standardized according to the present invention. Examples of such functions include, but are not limited to: tree functions, ComboBox functions, Scheduling functions, Calendar functions, entry spin fields for numeric data, a grid/spreadsheet, a masked edit field, a tab control, a time spin fields for clock data, a scroll bar, and pop-up/selection items from a menu bar.

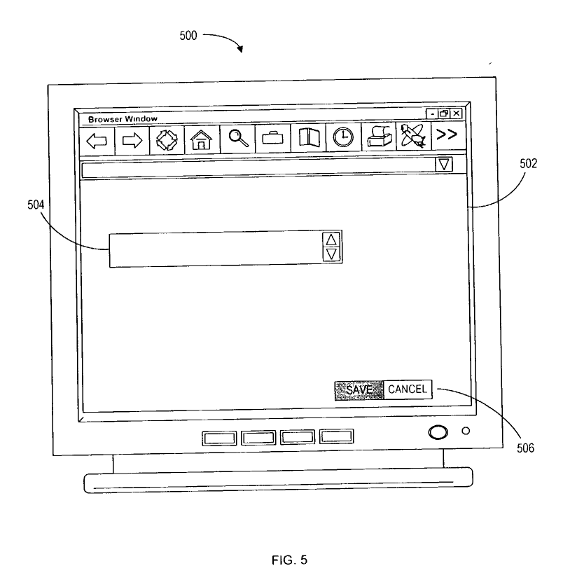

An exemplary user interface 502 is presented in FIG. 5. As displayed therein, a computer monitor 500 displays a web page including the user interface 502. In this example, the user interface 502 may include various of the image elements described above, including a scroll bar with entry field (504) and a tab control (506) that, for example, may gray-out (i.e. inactivate) a user-selected image element.

Each user interactive image element has a constructor that takes two parameters. The constructor is related to the image element by the first parameter that is passed to the constructor from the wizard 204 as a reference to the display element container. The first parameter is the name of the HTML element that contains the user interactive image element. The name may be generated by the user interactive image element's HTML wizard 204 in order to prevent a name collision with another function. The second parameter is a separately-generated event handling procedure that is the callback function for individual events on the object. An example of a constructor is:

myTree=newICCTree(myTreeviewDiv, myTreeviewEvents)

where “myTreeviewDiv” is an exemplary first parameter as described above, and “myTreeviewEvents” is an exemplary second parameter as described above.

Individual user interactive image elements will generate events upon, for example, selection of the image element by a user. Each event will pass to the event handling procedure based on the constructor. As an example, the signature for the event handling procedures:

function eventHandler(eventID, eventObject)

where “eventhandler” may be any function name that a developer chooses. A reference to the event handler procedure is passed to the constructor of the user interactive image element. Moreover, “eventID” is the event ID number. Individual ICC event IDs are contained in an executable code, such as ICCEvent js, and are a combination of the ICC domain number and sequential index starting, by way of example only, at 1.

An example of use of an event identifier is:

var ICC_DOMAIN=0X012F0000;

var ICCONCHANGE_EVENT=ICC_DOMAIN|1

where “eventObject” is a reference to the object on which the event occurred.

According to some embodiments, a number of events will be common across user interactive image elements. The ICCONCHANGE_EVENT above is an example. To reduce the amount of code necessary, these events are commonly provided such that the use of or changes to user interactive image element-specific eventIDs are minimized.

Examples of events and appropriate ICC domain numbers is as follows:

var ICCONCHANGE_EVENT=ICC_DOMAIN|1;

var ICCONBLUR_EVENT=ICC_DOMAIN|2;

var ICCONBEFORESELECT_EVENT=ICC_DOMAIN|3;

var ICCONSELECT_EVENT=ICC_DOMAIN|4;

var ICCONCLICK_EVENT=ICC_DOMAIN|5;

var ICCONDBCLICK_EVENT=ICC_DOMAIN|6;

var ICCONEXPAND_EVENT=ICC_DOMAIN|7;

var ICCONCOLLAPSE_EVENT=ICC_DOMAIN|8;

var ICCONBEFOREEDIT_EVENT=ICC_DOMAIN|9; and

var ICCONBEFORECHANGE_EVENT=ICC_DOMAIN|10.

According to some embodiments, individual user interactive image elements employ a common library of visual attributes, such as the common user interactive image element presentation formatting information 202, to user interactive image element the visual display attributes of the user interactive image element. Examples of such visual attributes include font, background, height and width. Each user interactive image element should also provide methods so that the developer of the user interactive image element may replace the user interactive image element presentation formatting information as necessary to create visual changes to the application or applications as a whole. For example, a tree user interactive image element may have user interactive image element presentation formatting information that represents a selected item. If the default visual indication for a selected item is not appropriate for the application, the developer may create new user interactive image element presentation formatting information that is appropriate and set the user interactive image element presentation formatting information for the selected nodes to the new user interactive image element presentation formatting information, thus providing greater flexibility in the architecture for such user interactive image elements.

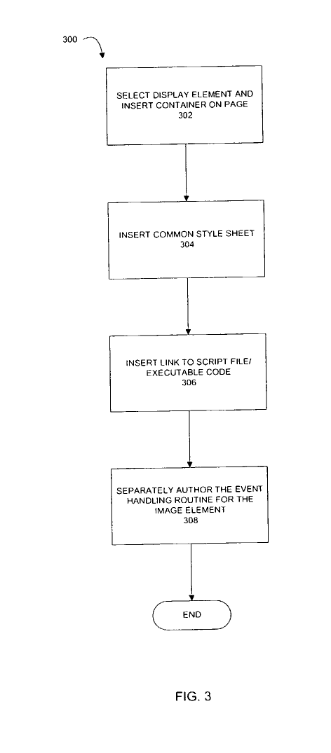

Reference is now made to FIG. 3, where an exemplary procedure 300 for developing an online application using the generic user interactive image element library of some embodiments of the present invention is shown. The procedure 300 begins when a display element is selected and a container is inserted on an electronic page (step 302). A link to common user interactive image element presentation formatting information (step 304) and a link to, for example, an executable code containing the implementation of the behavior of the user interactive image element may be provided (step306). A particular event handling procedure may then be individually authored for the user interactive image element (step 308), after which the procedure 300 ends.

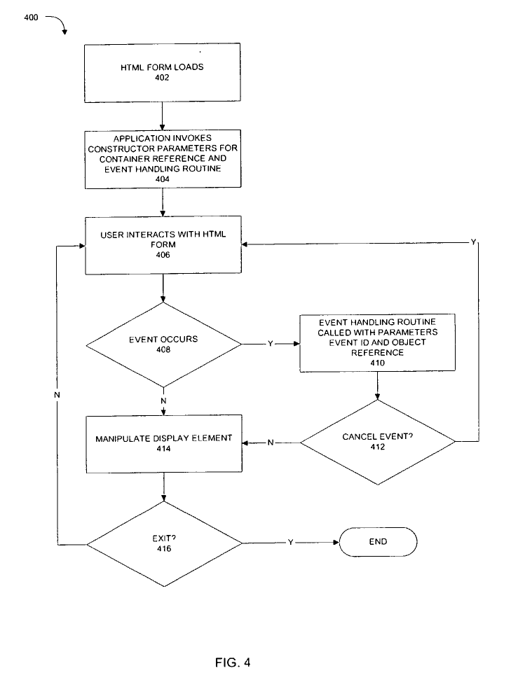

Turning now to FIG. 4, therein is depicted an exemplary procedure 400 performed by a user of the software developed according to some embodiments of the present invention. For this procedure 400, it is contemplated that the developer or another user, such as a consumer of the application, actuates a user interactive image element that was inserted into an online application according to the procedure depicted in FIG. 3.

The procedure 400 begins when an HTML page 200 is identified and loaded by the user (step 402). The application invokes a constructor having a parameter for the container reference and the event handling procedure(step 404). The user may next interacts with the HTML page 200 (step 406).

The application next determines whether an event occurs based on the user interaction with the HTML page 200 (step 408). If an event is detected, the procedure 400 continues to step 410. Otherwise, the procedure continues to step 414 below.

At step 410, the separately-generated event handling procedure is called. The event handling procedure may have parameters eventID and eventObject, as previously described. Next, the application determines whether the event has been cancelled, at for example, the user's request or by machine error (step 412). If the event is cancelled, the procedure 400 returns to step 406 above. Otherwise, the procedure 400 continues to step 414 where the display of the user interactive image element is changed to reflect a different visual attribute, such as by graying out (i.e. inactivating) the selected image element, according to the event handling procedure for that element.

If, after the event, the user exits the application, the procedure 404 ends. Otherwise, the procedure 400 returns to step 406 above where the application waits for further user interaction.

One advantage of the present invention is that it provides a paradigm for individual UI user interactive image element development. It also supports consistent usage from a development perspective, so that skills learned in creating one user interactive image element may be used to develop other user interactive image elements. There is also an advantage from a customer perspective. If individual applications use a standard library of user interactive image elements, there will be consistency in common functionality across separate applications produced by a common manufacturer. Manufacturers of such software applications may also readily change image elements and controls in their software simply by substituting or replacing common user interactive image element presentation formatting information and executable code that are used in the generation of various user interfaces.

Although the invention has been described in detail in the foregoing embodiments, it is to be understood that the descriptions have been provided for purposes of illustration alone and that other variations both in form and detail may be made thereupon by those skilled in the art without departing from the spirit and scope of the invention, which is defined solely by the appended claims.

What is claimed is:

1. A system supporting presentation of a user interface display image including an image element responsive to user selection, comprising:
a display processor for initiating generation of data representing an image element for presentation in a displayed image;
a database for associating said image element with an executable procedure for responding to user selection of said image element; and
an event processor for providing said procedure with:
(a) an event identifier for use in displaying an action desired upon user selection of said image element in said displayed image, and
(b) an image element identifier for identifying said image element from a plurality of image elements in response to user selection of said image element in said displayed image.

2. The system of claim 1, wherein said identifier is a member of a set of identifiers associated with a plurality of different user selectable image elements in said displayed image and said set of event identifiers is used for identifying a corresponding set of desired actions upon user selection of said different user selectable image elements.

3. The system of claim 1, wherein:
said display processor initiates generation of data representing a plurality of different user interface display image elements for presentation in said displayed image,
said database associates said plurality of image elements with a corresponding plurality of executable procedures, and
said event processor provides said procedures with a single event identifier in responding to user selection of different image elements of said plurality of image elements.

4. The system of claim 3, wherein said single event identifier is selected from a set of event identifiers associated with said plurality of image elements and identifying corresponding event types.

5. The system of claim 1, wherein said event processor provides said procedure with said event identifier and said image element identifier in a predetermined sequence.

6. The system of claim 1, wherein said executable procedure is associated with at least one of: hyper-text markup language code, dynamic hyper-text markup language code, extensible markup language code and standard generalized markup language code.

7. A system supporting presentation of a user interface display image including an image element responsive to user selection, comprising:
a command processor for processing a command received in response to user selection of an image element presented in a displayed image by identifying an executable procedure for responding to said received command; and
an event processor for providing said identified procedure with:
(a) an event identifier for use in displaying an action desired upon user selection of said image element in said displayed image, and
(b) an image element identifier for identifying said image element from a plurality of image elements in response to user selection of said image element in said displayed image.

8. The system of claim 7, further comprising:
a database for associating said received command with said identified procedure.

9. The system of claim 8, wherein said database associates said image element with said identified procedure for responding to user selection of said image element.

10. The system of claim 7, wherein:
said received command includes data identifying an image area of said displayed image containing said image element, and
said command processor provides said image area identification data to said processor.

11. A method for providing a consistent image element in a software application, comprising:
generating a user interface comprising an electronic document;
inserting within the document a first link to common user interactive image element presentation formatting information, the common user interactive image element presentation formatting information having at least one predetermined definition for a visual attribute of a image element selectable from the electronic document;
inserting within the document a second link to a executable code containing a predetermined processing procedure for the user interactive image element;
providing a unique event handling procedure for the user interactive image element; and
providing the online document to a user, wherein a visual attribute of the image element is determined by the common user interactive image element presentation formatting information, a performance of the inserted image element is determined by the executable code, and a log of the selection of the event is tracked by the independent event handling procedure.

12. The method of claim 11, wherein said generating a user interface further comprises:
inserting code within the document from a common wizard, the code comprising instructions for generating image elements for the image element function.

13. The method of claim 11, wherein the electronic document is a hyper-text mark-up language document.

14. The method of claim 11, wherein the executable code is an applet.

15. The method of claim 11, further comprising:
providing a constructor for calling the executable code upon selection of the user interactive image element.

16. The method of claim 15, wherein said constructor comprises:
a first parameter including a predetermined name of the user interactive image element; and
a second parameter including a name of the event handling routing for the user interactive image element.

17. The method of claim 16, wherein said predetermined name of the image element is generated by the wizard in order to prevent a name collision with a second image element.

18. The method of claim 16, wherein said name of the event handling procedure is determined by a developer.

19. An apparatus for providing consistent image elements in a plurality of differing software applications, comprising:
a processor; and
a memory in operative communication with the processor, the memory for storing a plurality of processing instructions directing the processor to:
generate a user interface comprising an electronic document;
insert within the document a first link to common user interactive image element presentation formatting information, the common user interactive image element presentation formatting information having at least one predetermined definition for a visual attribute of an image element selectable from the electronic document;
insert within the document a second link to a executable code, the executable code containing a predetermined processing procedure for the user interactive image element;
generate an independent event handling procedure for the user interactive image element; and
provide the online document to a user, wherein a visual attribute of the image element is determined by the common user interactive image element presentation formatting information, a performance of the inserted image element is determined by the executable code, and a log of the selection of the event is tracked by the independent event handling procedure.

20. A user interface, comprising:
a user-selectable image element provided within an electronic document;
a link, within the document, to common user interactive image element presentation formatting information that determines a visual attribute of the user interactive image element;
a link, within the document, to common executable code for implementing the user interactive image element; and
a call to a separately-generated event handling procedure for logging the selection of the user interactive image element, wherein the common executable code and the common user interactive image element presentation formatting information are provided with standard attributes and procedures, respectively, for handling common user interactive image elements among a variety of software applications.

21. The user interface of claim 20, wherein said call comprises a constructor including:
a first parameter corresponding to a name of the user interactive image element; and
a second parameter corresponding to the separately-generated event handling procedure.

22. A method for providing a consistent image element in a software application, comprising:
providing a browser-based user interface to a user, the user interface including a selectable user interactive image element, the image element having a visual attribute controlled by common user interactive image element presentation formatting information;
detecting a selection of the image element by the user; and, after said detecting:
manipulating the visual attribute of the user interactive image element, based on the common user interactive image element presentation formatting information and the selection;
calling common executable code for implementing the user interactive image element; and
executing a separately-generated event handling procedure corresponding to the image element for tracking the selection.

23. A system supporting a presentation of a user-selectable interface display command having an associated image element within a user interface, the system comprising:
a processor; and
a memory, in operative communication with the processor, for storing generic user interactive image element presentation formatting information having predetermined visual attributes and generic executable code having predetermined command execution procedures that are common to a plurality of differing software applications and associating the generic user interactive image element presentation formatting information and executable code with the interface display command, the memory further for storing and selectively retrieving a plurality of processing instructions enabling the processor to:
receive a user selection of the interface display command; and
execute an event handling procedure for the interface display command in response to the selection,
the event handling procedure not being common to the plurality of differing software applications, the event handling procedure having an event identifier for tracking an execution of the generic executable code associated with the interface display command and the event handling procedure further having an event image identifier for generating, from the generic user interactive image element presentation formatting information, a second image element corresponding to a visual representation of the selected command.

24. The system of claim 23, said event identifier being selected from a set of event identifiers associated with a plurality of different user-selectable image elements in the user interface, said plurality of event identifiers for tracking an execution of a plurality of selectable interface display commands for the user interface.

25. The system of claim 23, said user interface comprising at least one of: hyper-text markup language code, dynamic hyper-text markup language code, extensible markup language code and standard generalized markup language code.

26. The system of claim 23, said memory further for storing a database associating the interface display command with the generic executable code.

27. The system of claim 23, said memory further for storing a database associating the first image element with the generic executable code corresponding to the interface display command.

28. The system of claim 23, the interface display command including data identifying an image area of said user interface, said processing instructions further enabling the processor to:
display the second image element in the image area.
